(19) United States
(12) Patent Application Publication
(10) Pub. No.: US 2018/0211799 A1
(43) Pub. Date: Jul. 26, 2018

(54) STATIC AND DYNAMIC PIECE ASSEMBLY FOR KEY SWITCH

(71) Applicant: DONGGUAN CITY KAIHUA ELECTRONICS CO., LTD, Dongguan (CN)

(72) Inventor: Fuxi Wu, Dongguan (CN)

(21) Appl. No.: 15/928,451

(22) Filed: Mar. 22, 2018

Related U.S. Application Data
(63) Continuation of application No. PCT/CN2016/098098, filed on Sep. 5, 2016.

(30) Foreign Application Priority Data
Sep. 23, 2015 (CN) 201520738595.0

(51) Int. Cl. H01H 13/12; H01H 13/04

(52) U.S. Cl. CPC H01H 13/12; H01H 2231/002; H01H 2229/044; H01H 13/04

(57) ABSTRACT

A static and dynamic piece assembly for a key switch includes a static piece and a dynamic piece, an ejector rod being arranged in a middle section of the dynamic piece. The ejector rod being arranged on the dynamic piece of the static and dynamic piece assembly for the key switch increases contact sensitivity between the static piece and the dynamic piece; the ejector rod and the dynamic piece are formed in an integral structure by means of injection molding, such that connection strength between the ejector rod and the dynamic piece is improved; furthermore, installation ways of the dynamic piece are flexible and diversified. The static and dynamic piece assembly is simple in structure, convenient and practical, and increases the efficiency of contact and disconnection between the static piece and the dynamic piece, thus being suitable for large-scale promotion.

This application is a continuation of Serial No. PCT/CN2016/098098 filed on Sep. 5, 2016, which is expressly incorporated herein by reference.

### FIELD OF THE PRESENT APPLICATION

The present application relates to the technical field of computer key, especially to a static and dynamic piece assembly for key switch.

### BACKGROUND OF THE PRESENT APPLICATION

With development of technology and improvement of people's living standards, computers have become essential tools in daily life and work. The computer keyboard is a channel for inputting control information into a computer, which is evolved from the English typewriter keyboard. When it was originally appeared on a computer, the computer keyboard was a component referred to as “teletype typewriter”. Most of the keys in the computer keyboard use a static film and a movable film cooperated with each other, such that the keys are capable of being contacted or disconnected. Prior static and dynamic piece assembly for key switch still has huge potential for improvements, for example, installation ways for the moving piece lack of variety, efficiency of contacting and disconnecting the keys is low, and the keys are liable to failure, etc., which fails to meet people's requirements.

### SUMMARY

The present application aims to provide a static and dynamic piece assembly for key switch for dealing with the issues mentioned above.

In order to achieve the purpose above, the following technical schemes are provided: a static and dynamic piece assembly for key switch includes a static piece and a dynamic piece, in which an ejector rod is arranged in a middle section of the dynamic piece.

Preferably, the dynamic piece is bent into a U shape and installed inside a key dock.

Preferably, the dynamic piece is rectangular and installed inside a key dock.

Preferably, the ejector rod and the dynamic piece are formed in an integral structure by means of injection molding.

Compared with the prior art, beneficial effects of the present application include: the ejector rod being arranged on the dynamic piece of the static and dynamic piece assembly for the key switch increases contact sensitivity between the static piece and the dynamic piece; the ejector rod and the dynamic piece are formed in an integral structure by means of injection molding, such that connection strength between the ejector rod and the dynamic piece is improved; furthermore, installation ways of the dynamic piece are flexible and diversified. The static and dynamic piece assembly is simple in structure, convenient and practical, and increases efficiency of contact and disconnection between the static piece and the dynamic piece, thus being suitable for large-scale promotion.

### BRIEF DESCRIPTION OF THE DRAWINGS

FIG. 1 is a top view of the static and dynamic piece assembly for key switch;

FIG. 2 is a structural diagram of a first installation way of the present application;

FIG. 3 is a structural diagram of a second installation way of the present application;

FIG. 4 is a structural diagram of the static and dynamic piece assembly for key switch in a free state; and

FIG. 5 is a structural diagram of the static and dynamic piece assembly for key switch in a pressed state.

### DETAILED DESCRIPTION OF THE PREFERRED EMBODIMENT

The technical scheme in the embodiments of the present application are clearly and completely described below with reference to the accompanying drawings in the embodiments of the present application. Obviously, the drawings below are merely some, but not exclusive of the embodiments of the present application. All other embodiments obtained by those skilled in the art in the light of the drawings below without further creative works shall fall within the protection scope of the present application.

### The First Embodiment

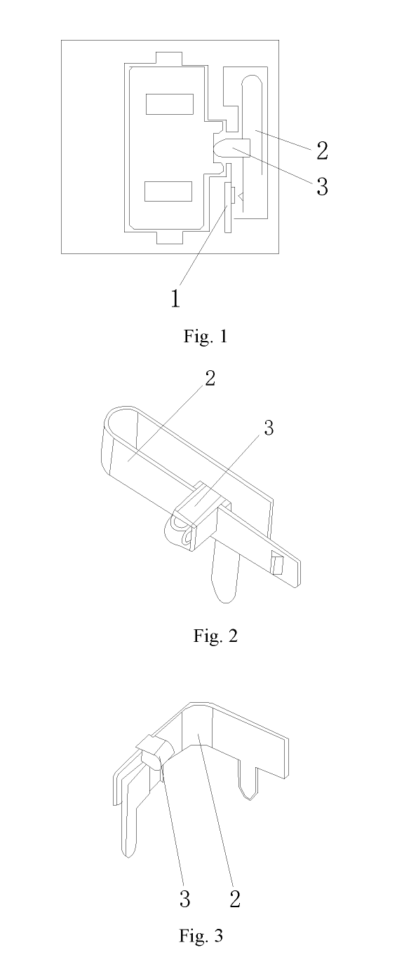

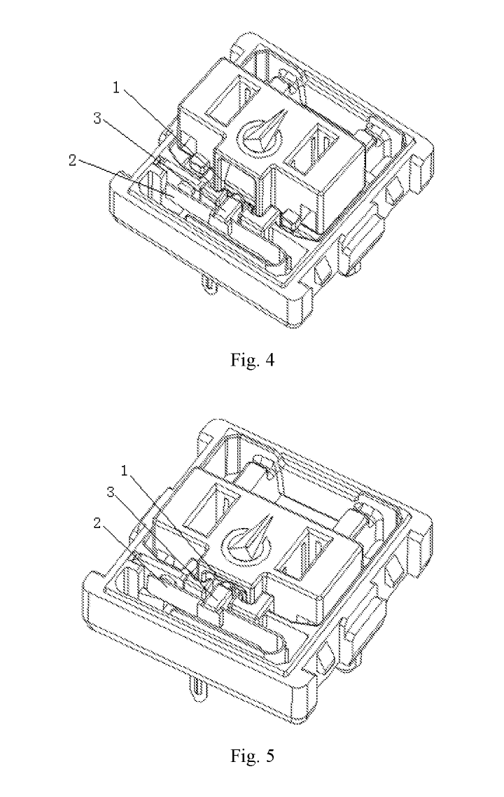

Please refer to FIGS. 1, 2, 4 and 5. A static and dynamic piece assembly for a key switch which includes a static piece 1 and a dynamic piece 2 is disclosed. The dynamic piece 2 is bent into a U shape and installed inside a key dock, an ejector rod 3 being arranged in a middle section of the dynamic piece 2. The ejector rod 3 and the dynamic piece 2 are formed in an integral structure by means of injection molding, such that the connection strength between the ejector rod 3 and the dynamic piece 2 is improved; furthermore, installation ways of the dynamic piece 2 are flexible and diversified, which makes the static and dynamic piece assembly for the key switch simple in structure, convenient and practical, and increases the efficiency for contact and disconnection between the static piece 1 and the dynamic piece 2.

### The Second Embodiment

Please refer to FIGS. 1, 3, 4 and 5. Another static and dynamic piece assembly for a key switch which includes a static piece 1 and a dynamic piece 2 is disclosed. The dynamic piece 2 is rectangular and installed inside a key dock, an ejector rod 3 being arranged in a middle section of the dynamic piece 2. The ejector rod 3 and the dynamic piece 2 are formed in an integral structure by means of injection molding, such that the connection strength between the ejector rod 3 and the dynamic piece 2 is improved; furthermore, installation ways of the dynamic piece 2 are flexible and diversified, which makes the static and dynamic piece assembly for the key switch simple in structure, convenient and practical, and increases the efficiency for contact and disconnection between the static piece 1 and the dynamic piece 2.

Although embodiments of the present invention have been shown and described, it will be apparent for those skilled in the art that various alternatives, modifications, replacement and variations may be made based on these embodiments without departing from the principles and spirit of the present invention. The scope of the invention is defined by the appended claims and their equivalents.

What is claimed is:

1. A static and dynamic piece assembly for key switch comprising a static piece and a dynamic piece, wherein an ejector rod is arranged in a middle section of the dynamic piece.

2. The static and dynamic piece assembly for key switch of claim 1, wherein the dynamic piece is bent into a U shape and installed inside a key dock.

3. The static and dynamic piece assembly for key switch of claim 1, wherein the dynamic piece is rectangular and installed inside a key dock.

4. The static and dynamic piece assembly for key switch of claim 1, wherein the ejector rod and the dynamic piece are formed in an integral structure by means of injection molding.
